(19) United States
(12) Patent Application Publication
(10) Pub. No.: US 2015/0347717 A1
(43) Pub. Date: Dec. 3, 2015

(54) HYBRID PERSONAL TRAINING SYSTEM AND METHOD

(71) Applicant: Xerox Corporation, Norwalk, CT (US)

(72) Inventors: Edul N. Dalal, Webster, NY (US); Wencheng Wu, Webster, NY (US)

(73) Assignee: Xerox Corporation, Norwalk, CT (US)

(21) Appl. No.: 14/293,325

(22) Filed: Jun. 2, 2014

(51) Int. Cl. G06F 19/00; G09B 5/06; G09B 5/14; A41D 1/00

(52) U.S. Cl. CPC G06F 19/3481; A41D 1/002; G09B 5/065; G09B 5/14

(57) ABSTRACT

Disclosed is a hybrid personal training method and system according to an exemplary embodiment of the system, a personal trainer or physical therapist works remotely or locally with clients in conjunction with an automated self-learning/self-assessing system for supervising the progress of the clients in the absence of the trainer.

### CROSS REFERENCE TO RELATED PATENTS AND APPLICATIONS

U.S. patent application Ser. No. ______, filed ______, by Edul N. Dalai et al. and entitled “VIRTUAL TRAINER OPTIMIZER METHOD AND SYSTEM” is incorporated herein by reference in its entirety.

### BACKGROUND

Physical therapy (PT) is a health care profession which deals with the treatment of physical impairments and disabilities which may be caused by injury, disease or congenital disorders. It provides improved mobility and functional ability, including greater strength and dexterity. Fitness training is similar, but is intended primarily for nominally healthy individuals. For the purposes of this disclosure, the differences between physical therapy and general fitness training are not significant, and are therefore considered interchangeably.

As the world's population ages, the demand for physical therapy is growing rapidly. Recent changes in healthcare laws place a greater emphasis on accountability of providers for client wellness and for medical outcomes rather than treatments. Consequently, there will be even greater demand for physical therapy, and health and fitness in the future.

There are many types of fitness training, including weight training, calisthenics, yoga, Pilates, aerobic dancing such as Zumba®, etc. Regardless of the type of fitness training, proper “form”, i.e., the way in which the exercise is performed, is essential. Proper exercise form maximizes the benefit of the exercise, while poor form results in an inefficient workout, wasting time and effort. Even more importantly, poor form can lead to serious injuries which may require medical treatment, loss of work, or permanent disability, in addition to pain and suffering.

The ultimate level of performance of an exercise program usually includes personal training, wherein a skilled personal trainer or therapist works with a client to implement a customized fitness training program. One of the most important functions of a personal trainer is to pay close attention to the form of the individual client's workout. Since extensive and frequent repetition is a key factor in any exercise program, having an ongoing program with a personal trainer and/or PT specialist can be a very expensive option.

At the other end of the scale, an alternative option is to perform a workout following generic instructions from a pre-recorded video. For general fitness training, such videos can be purchased on DVD relatively inexpensively. Of course, in the case of a prerecorded video, there is no customization and, in particular, there is no inspection of the exerciser for proper form, with consequent low efficiency and the risk of injury, as mentioned earlier.

Recently, remote training has become available, using video to link a trainer to a client, who may be in a different location or even in a different country. Because of the advantages associated with scheduling, transportation, gym fees, etc., remote personal training can be relatively less expensive and perhaps more convenient than conventional personal training. However, since the trainer's time is fully occupied during a training session, the potential reduction in cost relative to a “live” trainer is limited. Some remote training systems try to compensate for this by having the clients perform several unsupervised workouts between each remote supervised workout, for example, three unsupervised workouts for every one remote supervised workout. Since clients have to undertake them on their own with no remote or local supervision, these unsupervised workouts have all the drawbacks, such as low efficiency and risk of injury, as the pre-recorded video workouts.

Another recent development is a virtual training system, which utilizes an animated or recorded video instruction method, combined with a video analytic approach. A virtual training system analyzes the form in terms of pose of the client, i.e., the exerciser, and compares it to that of the instruction, and points out discrepancies to the client in a variety of ways. Examples include Nike+ Kinect® Training, Dance Central® 3, Adidas miCoach®, and NBA® Bailer Beats. All of these are available for the XBOX 360® and use the built-in Kinect® structured light depth measurement system to track the motions of the clients and thereby compare their form to that of the pre-recorded instructor. However, because a virtual training system does not have a human trainer inspecting the client's form, the ability to truly personalize the instruction to the client is limited. In particular, these systems can determine whether the client is within some tolerance of the correct form, but these systems lack the ability to guide the client toward attaining that goal. Furthermore, unlike personal trainers, these systems have limited capability in designing and assessing a truly personalized exercise routine for each individual, i.e., they do not have the expertise of human trainers to come up with personalized routines, and cannot assess routines with any unseen/untrained element.

### INCORPORATION BY REFERENCE

U.S. Pat. No. 8,617,081, by Mestha et al., issued Dec. 31, 2013 and entitled “Estimating Cardiac Pulse Recovery from Multi-Channel Source Data via Constrained Source Separation”;
U.S. Pat. No. 8,600,213, by Mestha et al., issued Dec. 3, 2013, and entitled “Filtering Source Video Data via Independent Component Selection”;
U.S. Pat. No. 8,582,811, by Wu et al., issued Nov. 12, 2013, and entitled “Unsupervised Parameter Settings for Object Tracking Algorithms”;
U.S. Patent Publication No. 2013/0345568, by Lalit Keshav Mestha et al., published Dec. 26, 2013, and entitled “Video-Based Estimation of Heart Rate Variability”;
U.S. Patent Publication No. 2013/0342756, by Beilei Xu et al., published Dec. 26, 2013, and entitled “Enabling Hybrid Video Capture of a Scene Illuminated with Unstructured and Structured Illumination Sources”;
U.S. Patent Publication No. 2013/0324876, by Edgar A. Bernal et al., published Dec. 5, 2013, and entitled “Processing a Video for Tidal Chest Volume Estimation”;
U.S. Patent Publication No. 2013/0322729, by Lalit Mestha et al., published Dec. 5, 2013, and entitled “Processing a Video for Vascular Pattern Detection and Cardiac Function Analysis”;
U.S. Patent Publication No. 2013/0218028, by Lalit Keshav Mestha, published Aug. 22, 2013, and entitled “Deriving Arterial Pulse Transit Time from a Source Video Image”;
U.S. Patent Publication No. 2013/0077823, by Mestha et al., published Mar. 28, 2013, and entitled “Systems and Methods for Non-Contact Heart Rate Sensing”;
U.S. Patent Publication No. 2013/0076913, by Xu et al., published Mar. 28, 2013, and entitled “System and Method for Object Identification and Tracking”;
U.S. Patent Publication No. 2013/0033484, by Liao et al., published Feb. 7, 2013, and entitled “System and Method for Interactive Markerless Paper Documents in 3D Space with Mobile Cameras and Projectors”;
U.S. Patent Publication No. 2012/0289850, by Xu et al, published Nov. 15, 2012, and entitled “Monitoring Respiration with a Thermal Imaging System”;
U.S. patent application Ser. No. 13/710,974, by Yi Liu et al., filed Dec. 11, 2012, and entitled “Methods and Systems for Vascular Pattern Localization Using Temporal Features”;
X. Zhu, D. Ramanan. “Face Detection, Pose Estimation and Landmark Localization in the Wild”, Computer Vision and Pattern Recognition (CVPR) Providence, R.I., June 2012, 8 pages;
Erik E. Stone and Marjorie Skubic, “Evaluation of an Inexpensive Depth Camera for Passive In-Home Fall Risk Assessment”, 2011, 5th International Conference on Pervasive Computing Technologies for Healthcare (PervasiveHealth) and Workshops, 7 pages;
“JointType Enumeration”, 3 pages, http://msdn.microsoft.com/en-us/library/microsoft.kinect.jointtype.aspx, Dec. 5, 2013;
“Kinect for Windows Sensor Components and Specifications”, http://msdn.micorsoft.com/en-us/library/jj131033.aspx, 2 pages, Mar. 14, 2014;
“Sensor Setup”, http://www.microsoft.com/en-us/kinectforwindows/purchase/sensor_setup.aspx, 2 pages, Mar. 13, 2014;
IBISWorld, “Physical Therapists Market Research Report”, 2013, 2 pages;
http://en.wikipedia.org/wiki/Dynamic_time_warping, 4 pages; and
“Kinect”, http://en.wikipedia.org/wiki/Kinect, 17 pages, Mar. 14, 2014, are incorporated herein by reference in their entirety.

### BRIEF DESCRIPTION

In one embodiment of this disclosure, described is a computer implemented remote personal training method comprising: a) capturing video of a client performing an exercise routine; b) extracting exercise features from the captured video, the extracted exercise features representative of the client's performance of the exercise routine; c) comparing the extracted exercise features representative of the client's performance to extracted exercise features representative of a reference video associated with a target performance of the exercise routine; and d) communicating information to one or both of the client and a remote personal trainer regarding the performance of the exercise routines by the client relative to the reference video based on the generated exercise performance results.

In another embodiment of this disclosure, described is a remote personal training system comprising: a controller configured to execute instructions to perform a remote personal training method, and one or more sensing elements operatively associated with the controller, the personal training method comprising: a) capturing video of a client performing an exercise routine; b) extracting exercise features from the captured video, the extracted exercise features representative of the client's performance of the exercise routine; c) comparing the extracted exercise features representative of the client's performance to extracted exercise features representative of a reference video associated with a target performance of the exercise routine; and d) communicating information to one or both of the client and a remote personal trainer regarding the performance of the exercise routines by the client relative to the reference video based on the generated exercise performance results.

In still another embodiment of this disclosure, described is a computer program product comprising: a non-transitory computer-usable data carrier storing instructions that, when executed by a computer, cause the computer to perform a remote personal training method comprising: a) capturing video of a client performing an exercise routine; b) extracting exercise features from the captured video, the extracted exercise features representative of the client's performance of the exercise routine; c) comparing the extracted exercise features representative of the client's performance to extracted exercise features representative of a reference video associated with a target performance of the exercise routine; and d) communicating information to one or both of the client and a remote personal trainer regarding the performance of the exercise routines by the client relative to the reference video based on the generated exercise performance results.

### BRIEF DESCRIPTION OF THE DRAWINGS

FIG. 1 is an exemplary embodiment of a video capturing system according to this disclosure.

FIG. 2 illustrates twenty body joints detected by KINECT®.

FIG. 3 illustrates person/body-part tracking capability of KINECT®.

FIG. 4 is a block diagram of an exemplary embodiment of a hybrid training system according to this disclosure.

FIG. 5 are examples of a scripted exercise routine including a start frame, peak frame and end frame associated with three exercise subroutines.

FIG. 6 illustrates an exercise trajectory of the right hand of the exerciser captured in the video frames shown in FIG. 5.

FIG. 7 illustrates an exercise trajectory of the left hand of the exerciser captured in the video frames shown in FIG. 5.

FIG. 8 illustrates the motion feature extracted from the video shown in FIG. 5 according to an exemplary embodiment of this disclosure.

### DETAILED DESCRIPTION

This disclosure provides a hybrid training method and system to provide personal training, using personal therapists or trainers working remotely or locally with clients, in conjunction with an automated self-learning/self-assessing system for supervising the clients in the absence of the trainer. In the resulting hybrid training system, most of the benefits of personal training would apply, but significant cost reduction can be accomplished by automating the inspection of a client for proper form by using computer vision technology. Some potential benefits of the disclosed embodiments include taking advantage of remote training and virtual training to reduce costs, flexible schedule, and overcome the issues with unsupervised training sessions. It also provides a customized reference form for clients by recording the correct personal actions under the supervision of a trainer. In addition, the computer vision system and machine learning algorithm can help a trainer and a client identify parts of the exercise routine/therapy routine that need to be improved.

As briefly discussed in the background section, one of the most important functions of a physical therapist or a personal fitness trainer is to pay close attention to the “form” of an individual patient's or client's workout. Proper form maximizes the benefit of the exercise, while poor form results in an inefficient workout, wasting time and effort. Even more importantly, poor form may lead to serious injuries which may require medical treatment, loss of work, or permanent disability, in addition to pain and suffering. An exercise program including personal training, wherein a skilled personal therapist or trainer works with a client to implement a customized training program, provides superior results in most cases. However, personal training can be very expensive.

Systems and methods are disclosed herein to provide personal training, using personal therapists or trainers working remotely or locally with clients, in conjunction with an automated self-learning/self-assessing system for supervising the clients in the absence of the trainer. In the resulting hybrid training system, most of the benefits of personal training are achieved while significant cost reduction can be accomplished by automating inspection of proper form by using computer vision technology.

With the advent of the Microsoft® Kinect® sensor, which is a low cost, depth capable, open source data acquisition sensor system, many new applications have been quickly brought to the market with minimal development effort. Since this disclosure and exemplary embodiments described herein leverages these benefits, a brief description of relevant features provided by Kinect® is given here.

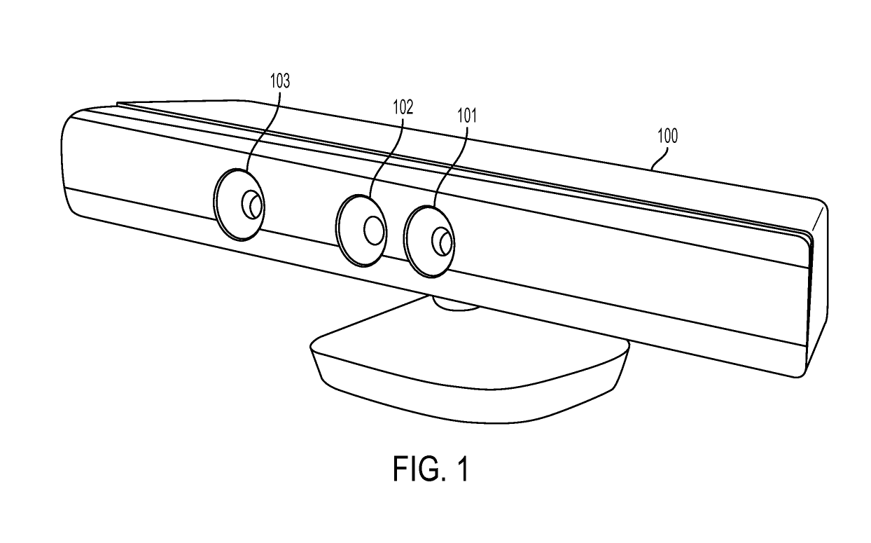

Embodiments of the disclosure can be integrated into or be in tandem with a camera system 100 that can involve a depth-sensing range camera, an infrared structured light source and a regular RGB color camera, as shown in the camera system 100 of FIG. 1. The depth-sensing camera 101 can approximate distances of objects by continuously projecting and interpreting reflected results from a structured infrared light source 103. The depth camera yields a so-called depth image, which is precisely aligned with the images captured by a RGB camera 102 to create an RGB and depth (RGBD) image. Thus embodiments of the disclosure can determine the depth of each pixel in the color images, establish a three-dimensional coordinate system with respect to the RGB camera, and transform each coordinate into real world coordinates. The RGB camera 102 may also be utilized to identify content or features of an identified surface, so that when gestures are made, the RGB camera can detect the gestures within the identified surface with respect to the identified content.

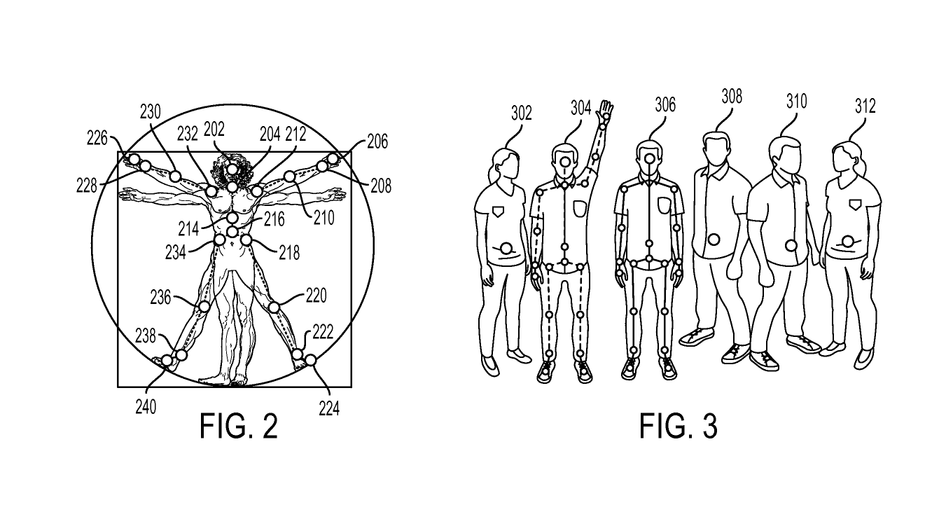

Beyond the raw imaging capability of acquiring RGB and depth (RGBD) videos, Kinect® also offers various capabilities in human body-part identification and tracking. FIG. 2 illustrates twenty body-joints detected by the open source Kinect® tool, which includes head 202, shoulder center 204, left hand 206, left wrist 208, left elbow 210, shoulder left 212, spine 214, hip center 216, hip left 218, left knee 220, left ankle 222, left foot 224, right hand 226, right wrist 228, right elbow 230, shoulder right 232, hip right 234, right knee 236, right ankle 238 and right foot 240. See “JointType Enumeration”, http://msdn.microsoft.com/en-us/library/microsoft.kinect.jointtype.aspx, 3 pages, Dec. 5, 2013, for more detail. FIG. 3 illustrates the human/human-part tracking offered by open source Kinect® tool. As shown in FIG. 3, the Kinect® sensor, as-is, can track up to 2 persons 304 and 306 with full human body-part tracking, plus up to 4 additional persons, 302, 308, 310 and 312. These features are more than enough to implement a Hybrid training method and system as described in this disclosure.

Provided herein is a system and method to provide remote personal training, as discussed above, using personal trainers working remotely with clients, in conjunction with an automated self-learning/self-assessing system for supervising the clients in the absence of the remote trainer. The resulting hybrid training system can provide benefits associated with a remote personal trainer with further cost reduction accomplished by automating the inspection for proper form by using machine vision technology, without resorting to unsupervised training.

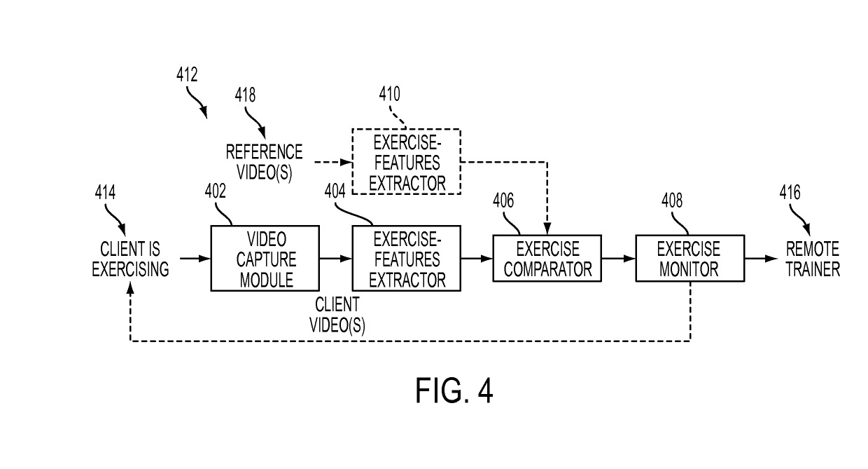

FIG. 4 depicts a high-level flowchart of a hybrid training system 412 according to an exemplary embodiment of this disclosure. During an offline mode, reference video(s) 418 are recorded and passed through an exercise-feature extractor 410 to yield a reference representation of the target/ideal exercise. At run-time, the client 414 will conduct the exercise while being “watched” by a video capture module 402, e.g., an RGB camera or a depth-enabled RGB camera such as Kinect®. The video will be passed, either real-time or not, through a similar exercise-feature extractor 404 to yield a current representation of the exercise. This will be compared to the reference representation of the target exercise by an exercise comparator 406 to recognize differences and optionally assess the differences. The results are then fed into an exercise monitor 408 to track the progress and determine what information to send to a remote trainer 416 and optionally to the client 414. The video processing and the feedback to remote trainer/client can be real-time or after the fact. The use of reference videos 418 together with video analytics enables an automated self-learning/self-assessing system for supervising clients in the absence of a remote trainer.

Further details about the modules in FIG. 4 are as follows:

In Exercise Features Extractor 410/404 module, a trajectory of at least one critical body part is extracted. The identification and tracking of the at least one critical body part can be achieved by open source full human body-part tracking via Kinect®, or alternatively, by the use of automated computer vision system along with special clothing worn by the client. See embodiment #3 discussed below. Optionally, the trajectory is normalized to account for the dimensional differences among exercisers, e.g., differences in height, limb lengths, etc. Additionally, this module may also perform automated video segmentation prior to the feature extraction using features such as distance to the starting point calculated from the trajectory.

In Exercise Comparator module 406, the trajectory of a reference exercise and that of a client's exercise is compared via methods such as dynamic time warping, see http://en.wikipedia.org/wiki/Dynamic_time_warping, 4 pages, or trajectory-normalization followed by calculating an error metric, e.g., mean-square error, MSE, calculation, etc.

In Exercise Monitor module 408, various levels of information and reporting can be generated, tracked, and sent to the remote trainer 416 and/or client 414, either in real-time or later. For example, when the current form is sufficiently deviated from the ideal form as represented by the reference video(s) 418, an instant video/audio feedback can be provided to the client while exercising. For another example, video segments associated with those exercises that differ from ideal representation by more than a threshold can be sent to the remote trainer weekly, or as they happen, for reviewing. For yet another example, video segments with largest deviation may be sent to the remote trainer first, and then the next largest, and so on. The purpose of thresholding and/or ranking the deviations is so that only essential segments may be reviewed by the trainer.

Described here are several exemplary embodiments of a hybrid training system as shown in FIG. 4. According to an exemplary embodiment #1, a remote, or even local, personal trainer guides the client to proper form for a given exercise. The client's form is then captured as a reference and analyzed by a computer vision system to yield a reference representation of a target exercise. For subsequent practice sessions, the trainer does not need to observe the client. The computer vision system compares the client's form with his/her proper form as previously determined by the trainer. Deviations from this form can be communicated to the client by visual and/or audio feedback. Moreover, the trainer can periodically review selected portions of video of the client's training sessions. The selected portions of video may be selected by the computer vision system, by comparing the client's form on each day with the previously determined proper form. Alternatively, the computer vision system may compare the client's form on the various training days and find the biggest outliers for further review by the trainer, thereby greatly reducing the amount of video that the trainer needs to review. Notably, by using the approach of comparing each exercise to the corresponding reference exercise, a potentially complicated action recognition and/or action quality assessment task is reduced to a simple deviation task. Furthermore, the method used to construct reference videos enables flexibility for a remote trainer to personalize the routine for each individual client. Note also that the reference video(s) could also include the remote trainer or other expert performing the exercise. In such cases, it is preferred to insert a step of normalizing the reference features to account for client-to-client variation, such as client height variations. Also in such cases, the differences between each captured exercise to the reference can be considered as a demerit metric for the quality of the captured exercise.

Exemplary embodiment #1 combines the personalization advantages of a remote training system, with advantages such as lower cost, flexible scheduling, etc., of a virtual training system. Since there will likely be many practice sessions monitored automatically for every initial session monitored by a trainer, the cost savings may be significant.

According to an exemplary embodiment #2, a real remote or local trainer identifies specific cases of persistent mistakes in form made by a client. This is routinely done by real personal trainers, but they have to continue to monitor these issues in many subsequent training sessions. In contrast, the automated system can learn these problem cases and then take on the task of monitoring the client in subsequent sessions, without requiring the trainer to be present.

According to an exemplary embodiment #3, a computer vision system is optionally assisted in body-part identification by use of specialized exercise clothing worn by a client. Such clothing can identify important parts such as elbows, knees, etc., by pattern and/or color coding, retroreflective or IR-reflective properties, etc. This can simplify the identification and tracking of critical body part(s) for typical video cameras, e.g. web-cam, that are not as capable as Kinect®.

According to an exemplary embodiment #4, a real trainer points out which aspects of the workout the client is not doing correctly, and the virtual trainer can follow up by critiquing the client in several subsequent exercise sessions.

According to an exemplary embodiment #5, audio and video 2-way communications are provided between the client and real and virtual trainers, e.g., voice commands.

According to an exemplary embodiment #6, a hybrid trainer system is integrated with smartphones or tablets, taking advantage of mobile apps for exercise tracking, calorie counting, etc., as well as with sensors such as accelerometers, etc.

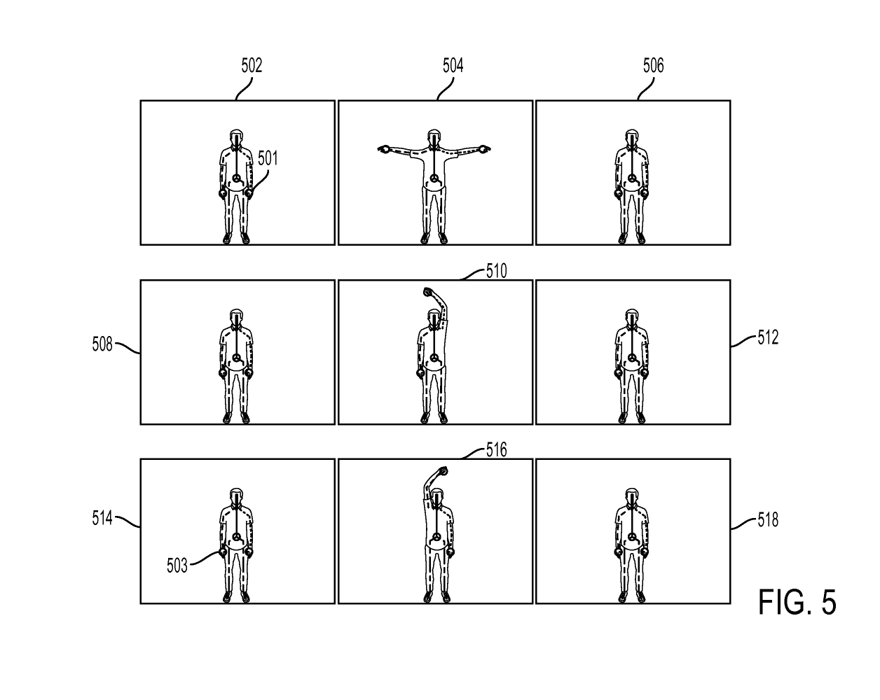

To further illustrate the operation of the hybrid training method and system described herein, a system was built with Kinect® as an imaging sensor and various analysis modules implemented in MATLAB. The system was tested on a set of 4 recorded videos, each following the same scripted exercise done by an actor. The scripted exercise consists of three routines as shown in FIG. 5: both arms up to horizontal (90° movement) 502, 504 and 506, left-arm up to the sky (180° movement) 508, 510 and 512, and right-arm up to the sky (180° movement) 514, 516 and 518. Each routine is repeated twice. Descriptions of the test RGB-D (Kinect®) videos are as follows:

Video#1: Reference video representing how a proper exercise should be done.

Video#2: Nominal exercise video#1 representing one of the later exercise videos to be assessed. Note that for this trial, an actor/exerciser tries to stand at the same place relative to the sensor when performing the exercise routines. The actor also tries to perform the exercise as close to the reference forms as possible. Thus the ground-truth for this video should be nominal.

Video#3: Nominal exercise video#2 representing one of the later exercise videos to be assessed. Note that for this trial, the actor actually stands at a different place further away relative to the sensor when performing the exercise routines. The actor also tries to perform the exercise as close to the reference forms as possible. Thus the ground-truth for this video should be nominal. The purpose of this video is to demonstrate the robustness of the test system.

Video#4: Poorly performed exercise video#1 representing one of the later exercise videos to be assessed. Note that for this trial, the actor tries to stand at the same place relative to the sensor when performing the exercise routines. The actor also intentionally performs the exercise somewhat poorly when compared to the reference forms. Thus the ground-truth for this video should be poor-form. The purpose of this video is to demonstrate the accuracy/detectability of the test system.

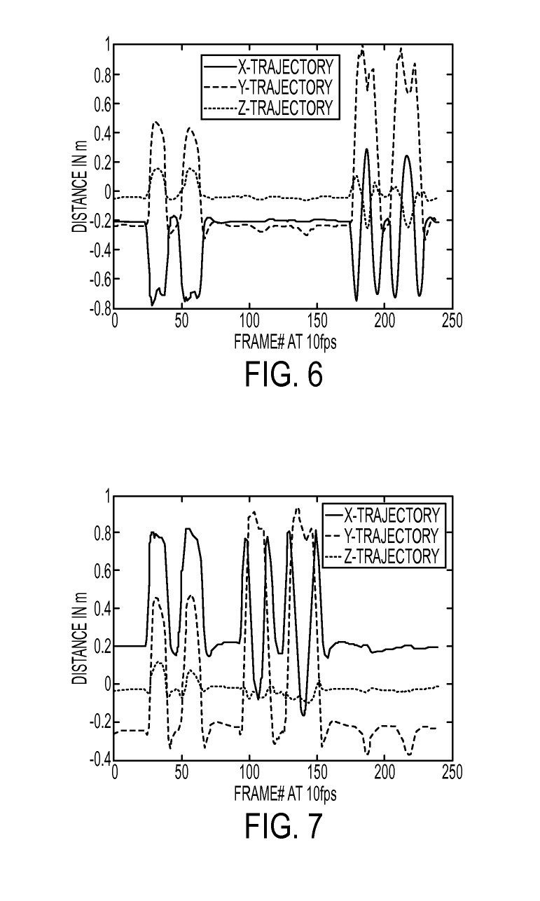

Exercise-feature extraction: For each video, all 20 body-joints, as shown in FIG. 2, of the exerciser are detected and tracked frame by frame using open source tools of Microsoft® Kinect®. The output of this step is a 20×Kᵥ×3, v=1˜4 3-D arrays (tensor) representing the xyz-trajectory of the 20 body-joints for the v^{th} videos over the length of Kᵥ frames. Note that videos do not have equal time lengths since it is not likely that the exerciser performs the different exercises within identical time frames. For this experiment the relative trajectory of the left hand (diamond 501) to the hip-center, and the relative trajectory of the right hand (diamond 503) to the hip-center are the features utilized. That is, we have two trajectory features: a Kᵥ×3 matrix for right-hand movement (FIG. 6) and another Kᵥ×3 matrix for left-hand movement (FIG. 7). Note that for a thorough analysis of the exerciser's form, it may be required to use the entire set of body-joints trajectories, preferably normalized, in xyz-axes as features. Furthermore, different weights based on the importance of the trajectory for each body-joint may be imposed, depending on each exercise routine.

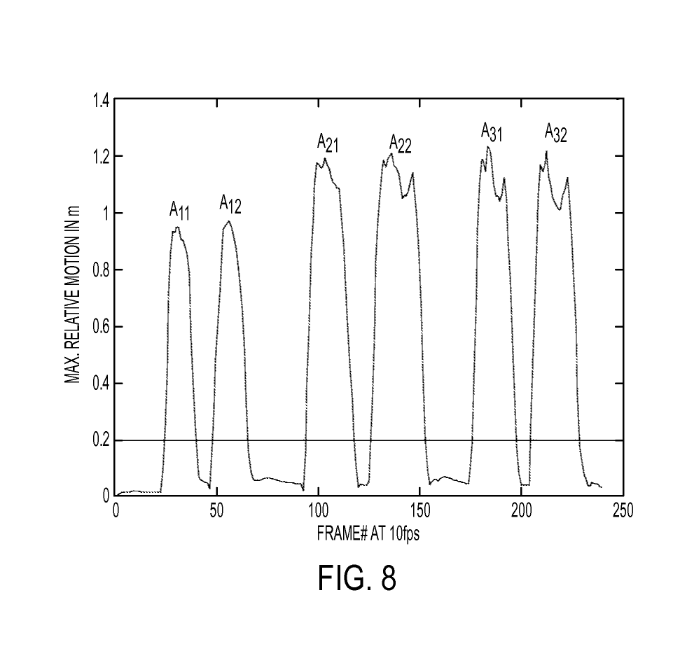

Exercise-action-segmentation: Given the body-joints trajectory, as shown in FIG. 6 and FIG. 7, each action in the exercise routines can be segmented using a feature referred to as a movement feature for purposes of this disclosure. The movement is calculated for each frame by first computing the distance between the starting joint position to the current joint position for all joints of interest and then taking the maximum among them. FIG. 8 shows the corresponding movement feature derived from FIGS. 6 and 7. With the introduction of this movement feature, actions within exercise routines can be relatively easily segmented out via simple thresholding. In other words, the movement feature captures the maximal physical movement of all body-joints of interest relative to its initial/rest position. Consequently, the action can be segmented by looking at segments that exhibit sufficient physical movement from body-joints of interest. When constructing the movement feature, imposition of different weights on the trajectories of different body-joints can also be performed.

Derivation of reference form and thresholds: Once the exercise-feature tensor and the corresponding action segments have been determined, the reference exercise form is simply the corresponding segment of trajectory in the exercise-feature tensor. Additionally, when an action is performed more than once in a reference video, e.g. twice here, the reference exercise form can alternatively be an average trajectory, and the deviations, e.g., standard deviation, MSE, etc., between individual repeat and the average can be used as a measure of what is considered an expected deviation, i.e., threshold, between repeats of proper form vs. the excessive deviation due to improper from. For the experiment described herein, an average trajectory of the two repeats as the reference form for the 3 actions/routines shown in FIG. 5. In addition, the maximal MSE between repeats and the average as a measure of expected variation for each action was calculated.

Exercise comparisons: Without loss of generality, the exercise comparator may, in some cases, consider an action performed at different speeds to be acceptable. Following steps (1)˜(2) as described below for Video#2˜Video#4, the exercise-feature is obtained for each action in each video, i.e., the left and right hand trajectories. The comparison is done simply by (1) calculating the MSE between the left-hand trajectory of a given action of a test video and the left-hand trajectory of the corresponding reference form, (2) calculating the MSE between the right-hand trajectory of a given action of a test video and the right-hand trajectory of the corresponding reference form, (3) taking the maximum of (1) and (2), and (4) normalizing the maximal value by the expected MSE learned in Step (3). Conceptually, this corresponds to initially picking out the worst deviations among all body-joints of interest as compared to the reference form, and then seeing how many times this value is compared to the expected deviation derived from the repeats of the reference form. This normalized deviation for all actions in the test videos are listed in Table 1. As shown in Table 1, it is clear that the disclosed system and method can accurately identify all six actions, e.g., using a threshold of 8, that are not performed properly in Video#4. Based on the results for Video#3, it is clear that the disclosed algorithm is robust relative to the variations caused by the position of the exerciser to the sensor.

TABLE 1

| | Action1-R1 | Action1-R2 | Action2-R1 | Action 2-R2 | Action 3-R1 | Action3-R2 |
|---|---|---|---|---|---|---|
| Video#2 | 3.9 | 4.0 | 6.9 | 5.4 | 1.2 | 1.4 |
| Video#3 | 3.1 | 2.0 | 3.9 | 3.9 | 0.9 | 1.6 |
| Video#4 | 74.0 | 116.7 | 16.5 | 14.8 | 12.3 | 9.7 |

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer implemented remote personal training method comprising:
a) capturing video of a client performing an exercise routine;
b) extracting exercise features from the captured video, the extracted exercise features representative of the client's performance of the exercise routine;
c) comparing the extracted exercise features representative of the client's performance to extracted exercise features representative of a reference video associated with a target performance of the exercise routine; and
d) communicating information to one or both of the client and a remote personal trainer regarding the performance of the exercise routines by the client relative to the reference video based on the generated exercise performance results.

2. The computer implemented remote personal training method according to claim 1, wherein the step of comparing the extracted exercise features includes one or more of:
evaluating the client's performance of the exercise routine;
identifying an incorrect form of the client; and
tracking a progression of the client's performance of the exercise routine.

3. The computer implemented remote personal training method according to claim 1, further comprising:
e) the remote personal trainer communicating with the client based on the information communicated to the remote personal trainer in step d).

4. The computer implemented remote personal training method according to claim 1, wherein the remote personal trainer is one of a physical therapist and a fitness trainer.

5. The computer implemented remote personal training method according to claim 1, wherein the reference video includes one or more of an actual performance of the exercise routine by the client under the supervision of the remote trainer, an actual performance of the exercise routine by a trainer, and an actual performance of the exercise routine generated by animation.

6. The computer implemented remote personal training method according to claim 1, step b) comprising:
extracting one or more trajectories of one or more body parts associated with the client's performance of the exercise routine.

7. The computer implemented remote personal training method according to claim 6, wherein the one or more trajectories are normalized.

8. The computer implemented remote personal training method according to claim 6, wherein the one or more body parts are detected using one or more of an RGB camera, a depth-sensing camera and coded clothing.

9. The computer implemented remote personal training method according to claim 1, step c) comprising:
performing one of dynamic time warping and trajectory-normalization.

10. The computer implemented remote personal training method according to claim 1, wherein the information communicated to one or both of the client and the remote personal trainer includes one or more of video and audio.

11. The computer implemented remote personal training method according to claim 1, wherein information communicated to one or both of the client and the remote personal trainer is based on one of thresholding video segments and ranking video segments.

12. A remote personal training system comprising:
a controller configured to execute instructions to perform a remote personal training method, and one or more sensing elements operatively associated with the controller, the personal training method comprising:
a) capturing video of a client performing an exercise routine;
b) extracting exercise features from the captured video, the extracted exercise features being representative of the client's performance of the exercise routine;
c) comparing the extracted exercise features representative of the client's performance to extracted exercise features representative of a reference video associated with a target performance of the exercise routine; and
d) communicating information to one or both of the client and a remote personal trainer regarding the performance of the exercise routines by the client relative to the reference video based on the generated exercise performance results.

13. A remote personal training system according to claim 12, wherein the step of comparing the extracted exercise features includes one or more of:
evaluating the client's performance of the exercise routine;
identifying an incorrect form of the client; and
tracking a progression of the client's performance of the exercise routine.

14. The remote personal training system according to claim 12, wherein the method further comprises:
e) the remote personal trainer communicating with the client based on the information communicated to the remote personal trainer in step d).

15. The remote personal training system according to claim 12, wherein the remote personal trainer is one of a physical therapist and a fitness trainer.

16. The remote personal training system according to claim 12, wherein the reference video includes one or more of an actual performance of the exercise routine by the client under the supervision of the remote trainer, an actual performance of the exercise routine by a trainer, and an actual performance of the exercise routine generated by animation.

17. The remote personal training system according to claim 12, step b) comprising:
extracting one or more trajectories of one or more body parts associated with the client's performance of the exercise routine.

18. The remote personal training system according to claim 17, wherein the one or more trajectories are normalized.

19. The remote personal training system according to claim 17, wherein the one or more body parts are detected using one or more of an RGB camera, a depth-sensing camera and coded clothing.

20. The remote personal training system according to claim 12, step c) comprising:
performing one of dynamic time warping and trajectory-normalization.

21. The remote personal training system according to claim 12, wherein the information communicated to one or both of the client and the remote personal trainer includes one or more of video and audio.

22. The remote personal training system according to claim 12, wherein information communicated to one or both of the client and the remote personal trainer is based on one of thresholding video segments and ranking video segments.

23. A computer program product comprising:
a non-transitory computer-usable data carrier storing instructions that, when executed by a computer, cause the computer to perform a remote personal training method comprising:
a) capturing video of a client performing an exercise routine;
b) extracting exercise features from the captured video, the extracted exercise features representative of the client's performance of the exercise routine;
c) comparing the extracted exercise features representative of the client's performance to extracted exercise features representative of a reference video associated with a target performance of the exercise routine; and
d) communicating information to one or both of the client and a remote personal trainer regarding the performance of the exercise routines by the client relative to the reference video based on the generated exercise performance results.

24. The computer program product according to claim 23, comprising:
e) the remote personal trainer communicating with the client based on the information communicated to the remote personal trainer in step d).

25. The computer program product according to claim 23, wherein the reference video includes an actual performance of the exercise routine by the client under the supervision of the remote trainer.
